(19) United States
(12) Patent Application Publication
(10) Pub. No.: US 2005/0035571 A1
(43) Pub. Date: Feb. 17, 2005

(54) Article of manufacture for a hollow one piece plastic injection molded bicycle frame and process for making same

(76) Inventor: Keith Allen Huck, Sterling Heights, MI (US)

Correspondence Address: KEITH A. HUCK, 12316 MYLES CT, STERLING HGTS., MI, 48313, US

(21) Appl. No.: 10/804,497

(22) Filed: Oct. 27, 2004

Related U.S. Application Data
(60) Provisional application No. 60/456,883, filed on Mar. 24, 2003.

(51) Int. Cl. B62K 19/16

(52) U.S. Cl. 280/281.1

(57) ABSTRACT

An article of manufacture for a hollow one piece plastic injection molded bicycle frame with a hollow plastic injection molded bicycle frame with the ability to attach a front fork assembly, a seat assembly, a pedal crank assembly and, rear wheel assembly, a plastic injection mold to produce a bicycle frame that is one piece hollow and free from welding and brazing, the ability to select from a varity of polymers (plastic resin) to produce a one piece hollow bicycle frame depending on the bicycling application, a mold which produces a tin bismuth core of a bicycle frame, and a plastic injection mold which produces a plastic bicycle frame.

### CROSS REFERENCE TO RELATED APPLICATIONS

This application is based on provisional application Ser. No. 60/456,883, filed on Mar. 24, 2003.

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of bicycles and more specifically to an article of manufacture for a hollow one piece plastic injection molded bicycle frame and process for making same.

Present bicycle frames are manufactured by welding together sections of tubing made out of steel or aluminum. Another way of producing a bicycle frame is by laying layers of fiber-reinforced plastics over bladders or into a mold and shaping the fiber to the design intended. One more way was to produce a mold and inject it with plastic which filled the cavity of the mold and produced a heavy solid bicycle frame.

### The Relevant Patents

U.S. Pat. No. 6,340,509

U.S. Pat. No. 6,340,509, to Nelson et al., has an issue date of Jan. 22, 2002. The patent is directed towards bicycle frame components without laps which are made by a method comprising shaping a fluid-removable core in the general form of the component, placing a flexible inflatable bladder around the core, wrapping over the assembly of core and bladder at least one ply of fiber impregnated with a curable resin, forming a cured part by inflating the bladder while the assembly of core, bladder, and impregnated fiber is in a mold to force the plies against the inner surfaces of the mold, such that compaction of the fiber against the mold is predominantly from the bladder inflation and not from the core, and heating to cure the resin to form a cured part, removing the bladder and the fluid-removable core from the interior of the cured part by disintegrating the fluid-removable core with a fluid sufficient to allow removal of the core and the bladder.

U.S. Pat. No. 6,458,306

U.S. Pat. No. 6,458,306, to Nelson et al., has an issue date of Oct. 1, 2002. The patent is directed towards bicycle frame components without laps which is made by a method comprising; shaping a fluid-removable core in the general form of the component, placing a flexible inflatable bladder around the core, wrapping over the assembly of core and bladder at least one ply of fiber impregnated with a curable resin, forming a cured part by inflating the bladder while the assembly of core, bladder, and impregnated fiber is in a mold to force the plies against the inner surfaces of the mold, such that compaction of the fiber against the mold is predominantly from the bladder inflation and not from the core, and heating to cure the resin to form a cured part, removing the bladder and the fluid-removable core from the interior of the cured part by disintegrating the fluid-removable core with a fluid sufficient to allow removal of the core and the bladder.

U.S. Pat. No. 6,270,104

U.S. Pat. No. 6,270,104, to Nelson et al., has an issue date of Aug. 7, 2001. The patent is directed towards a bicycle frame which is formed by selecting and adhesively joining previously formed and precured composite tubes to previously formed and precured composite lug components. The precured lug components are separately shaped from preforms comprising a plurality of resin impregnated fibrous layers formed into a stack in which the fibers of adjacent layers cross one another, with such preforms of each such lug component being in the nature of a set of similarly shaped overlapping halves of the frame lug component to be formed therefrom, with such overlapping halves being brought together in a hollow nature and placed around an inflatable bladder to form an assemblage that is applied between a set of female mold halves of molding tools that are closed for forming the lug component itself, and the resulting assemblage is subjected to a curing heat, with such bladder of each two hundred (200) set of preforms being arranged to first be pressurized to a pressure greater than or equal to two hundred (200) pounds per square inch, for urging the respective preforms against the mold shaping surfaces opposing same, thereby providing a high laminate compaction pressure during cure that produces a uniform, thin walled, strong, tubular, lug component. The said lug components are also each formed with one or more male members or plugs for closely fitting into adjacent open ends of the aforementioned all-composite tubes. Such composite tubes are formed by wrapping a preform, that is similar to the lug component preform, around a mandrel and cured, with the wrap being subject to a compaction pressure therearound during cure, thereby providing a thin walled high strength tube, for forming of the bicycle frame.

U.S. Pat. No. 6,264,878

U.S. Pat. No. 6,264,878, to Busby, has an issue date of Jul. 24, 2001. The patent is directed towards a method for forming a bicycle frame which comprises the initial step of placing a hollow core formed from a semi-rigid material and having a polymer impregnated fiber material applied there to into a first mold section. A second mold section is then mated to the first mold section such that a cavity having a desired frame shape is defined there between. The core and the polymer impregnated fiber material applied thereto are then heated to a temperature level sufficient to make the core pliable. The core is then inflated so as to cause the polymer impregnated fiber material applied thereto to substantially conform to the shape of the cavity.

U.S. Pat. No. 5,456,481

U.S. Pat. No. 5,456,481, to Allsop et al., has an issue date of Oct. 10, 1995. The patent is directed towards a bicycle with a frame which is formed of composite materials. The frame of this bicycle includes a head section or module that is attached to two body units. The body units are formed by injection molding and include outer shells and inner ribs. Alternatively, the body units may be formed of a urethane core with a stiffened fiberglass, carbon fibers, or like nonmetallic skin. The head section and body units are formed with bores in which sleeves and cables are seated to accommodate the installation of the other components of the bicycle to the frame. The body is further formed with a set of rearwardly extending members that form the chain stays of the bicycle. Dropouts are seated in recesses formed in the chain stays. The bicycle includes a front derailleur/rear brake assembly with a front derailleur that can be both selectively moved up and down and selectively pivoted along a lateral axis of the bicycle. A one-piece, injection-molded frame and methods of construction are also disclosed.

U.S. Pat. No. 6,123,353

U.S. Pat. No. 6,123,353, to Bennett et al., has an issue date of Sep. 26, 2000. The patent is directed towards a hydraulic valve operating circuit for providing positive opening and closing of a method of forming a tubular frame, e.g., a bicycle frame, from two substantially symmetrical frame-halves utilizes a plurality of interconnected half-tubular elements. Each half-tubular element has an exterior surface, an interior surface, and longitudinal edges that extend between the exterior and interior surfaces in the direction of the longitudinal axis of the half-tubular element. The surfaces of the longitudinal edges of the half-tubular elements are shaped such that corresponding edges of corresponding half-tubular elements in the left and right half-frames may easily be interengaged, and adjusted along the respective longitudinal axes of the half-tubular elements that are being joined. Preferably, the longitudinal free edges are stepped in the radial direction such that each level is substantially planar and smooth along the respective longitudinal axis of the half-tubular element. The longitudinal edge of one of the half-tubular elements may include parallel steps extending in opposite directions to thereby form a groove into which a step of the corresponding longitudinal edge of the corresponding half-tubular element in the other half-frame may be inserted. The latter joint type provides additional reinforcement of the connection of the half-frames. Further reinforcement in the stay area of the bicycle frame may be provided, either in the form of a reinforcement arch positioned within the tubular legs of the stays, or in the form of a one-piece, unitary inner stay element positioned between the outer stay elements that are part of the frame-halves.

Sections of steel or aluminum must be welded to form a bicycle frame. These welded joints are common areas of stress and fatigue which can fail and cause injuries to riders.

Steel and aluminum frames can also obtain their shape by extruding, which can cause a thinning of the walls which can also show signs of stress and failure and possibility lead to injuries.

Steel bicycle frames are very heavy and are inexpensive. Aluminum is lighter but manufacturing costs are also increased. Even lighter is a composite bicycle frame. The composite bicycle frame is very light but is also very expensive to manufacture.

### BRIEF SUMMARY OF THE INVENTION

The primary object of the invention is to provide a one piece bicycle frame without welding or brazing.

Another object of the invention is to provide a bicycle frame with or without the option to paint.

Another object of the invention is to provide a bicycle frame that is very light weight.

A further object of the invention is to provide a high scale bicycle frame at a considerably lower cost.

Yet another object of the invention is to have the ability to be very creative for the design and shape of the bicycle frame.

Still yet another object of the invention is to provide the manufacturer with a choice of a varity of polymers (plastic resin) for different applications of bicycling.

Another object of the invention is to provide a plastic injection molder the ability to produce high volumes of bicycle frames with consistency.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed an article of manufacture for a hollow one piece plastic injection molded bicycle frame comprising: a hollow plastic injection molded bicycle frame comprising of the ability to attach a front fork assembly, a seat assembly, a pedal crank assembly and, rear wheel assembly, a plastic injection mold to produce a bicycle frame that is one piece hollow and free from welding and brazing, the ability to select from a varity of polymers (plastic resin) to produce a one piece hollow bicycle frame depending on the bicycling application, a mold which produces a tin bismuth core of a bicycle frame, and a plastic injection mold which produces a plastic bicycle frame.

In accordance with a preferred embodiment of the invention, there is disclosed a process for a hollow one piece plastic injection molded bicycle frame comprising the steps of: a hollow plastic injection molded bicycle frame comprising of the ability to attach a front fork assembly, a seat assembly, a pedal crank assembly, rear wheel assembly, a plastic injection mold to produce a bicycle frame that is one piece hollow free from welding and brazing, the ability to select from a varity of polymers (plastic resin) to produce a one piece hollow bicycle frame depending on the bicycling application, a mold which produces a tin bismuth core of a bicycle frame, and a plastic injection mold which produces a plastic bicycle frame.

### BRIEF DESCRIPTION OF THE DRAWING

The drawing constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a sketch of a hollow one piece plastic injection molded bicycle frame, the invention.

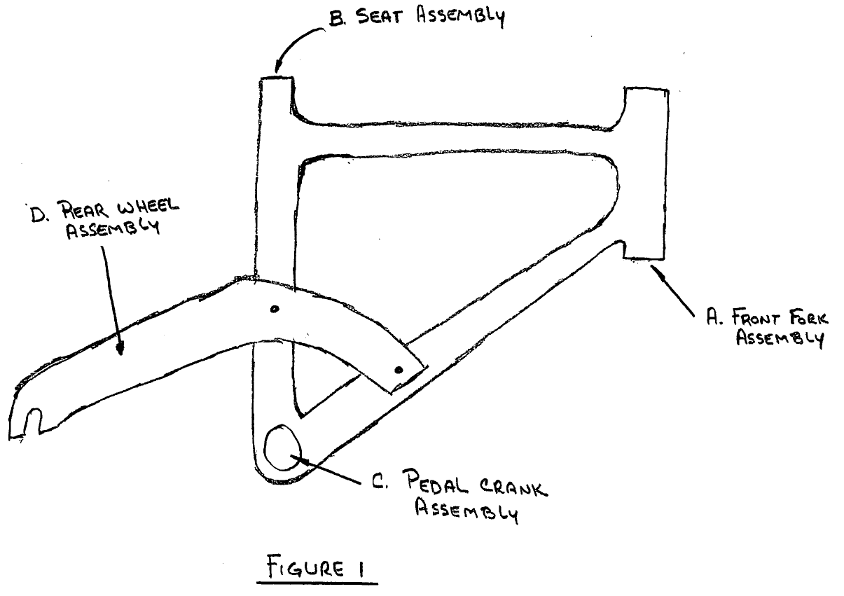

A. Front Fork Assembly

B. Seat Assembly

C. Pedal Crank Assembly

D. Rear Wheel Assembly

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Currently bicycle frames are assemblies constructed from individual tubes which are welded or brazed together or by applying layers of fiber strips and resin around a bladder. The bladder is removed to form a hollow bicycle frame. The current method of producing bicycle frames is not cost effective, or have additional processes, which increases the possibility of a failure. By reducing the number of manufacturing processes and having a tighter control of the processes an improved part will be produced. This new process for the production of a hollow one piece plastic injection molded bicycle frame is accomplished by, A mold of the bicycle frame is constructed out of steel or aluminum to a desired design. This mold represents two cavities and when put together will produce a large hollow section which will form the shape of the bicycle frame or the shape of a component of the bicycle or bicycle frame. The mold is then injected with Tin Bismuth, and when cooled will produce a solid Tin Bismuth part of the hollow area of the desired design of the bicycle frame or the component of the bicycle frame. A second mold is constructed out of steel or aluminum. This mold will be the finished shape of the desired design shape of the outside or the side that everyone will see of the bicycle frame or component of the bicycle frame. The Tin Bismuth part is then placed in the second mold, the plastic injection mold. The pre selected choice of polymer with or without a color additive, is then injected into the steel or aluminum mold. The polymer will encapsulate the tin bismuth part. When cooled the part produced will be a tin bismuth part encapsulated with a thin layer of the selected polymer. The entire part is then submerged into hot oil and when heated to a temperature of 325 degrees Fahrenheit will cause the tin bismuth to melt. Once the melting process has been completed, what is left remaining will be a hollow part made of the choice polymer. The part is now ready for the completion of the manufacturing process of producing a finished bicycle by attaching front fork assembly, seat, pedal crank and, rear wheel.

While the invention has been described in connection with a preferred embodiment, it is not intended to limit the scope of the invention to the particular form set forth, but on the contrary, it-is intended to cover such alternatives, modifications, and equivalents as may be included within the spirit and scope of the invention as defined by the appended claims.

1. An article of manufacture for a hollow one piece plastic injection molded bicycle frame comprising:
A. A hollow plastic injection molded bicycle frame comprising of the ability to attach a front fork assembly, a seat assembly, a pedal crank assembly and, rear wheel assembly;
B. A plastic injection mold to produce a bicycle frame that is one piece hollow and free from welding and brazing;
C. The ability to select from a verity of polymers (plastic resin) to produce a one piece hollow bicycle frame depending on the bicycling application,
D. A mold which produces a tin bismuth core of a bicycle frame; and a plastic injection mold which produces a plastic bicycle frame.

2. A process for a hollow one piece plastic injection molded bicycle frame comprising the steps of:
A. A hollow plastic injection molded bicycle frame comprising of the ability to attach a front fork assembly, a seat assembly, a pedal crank assembly and, rear wheel assembly;
B. A plastic injection mold to produce a bicycle frame that is one piece hollow, and free from welding and brazing;
C. The ability to select from a varity of polymers (plastic resin) to produce a one piece hollow bicycle frame depending on the bicycling application;
D. A mold which produces a tin bismuth core of a bicycle frame; and a plastic injection mold which produces a plastic bicycle frame.
